(19) United States
(12) Patent Application Publication
(10) Pub. No.: US 2008/0252596 A1
(43) Pub. Date: Oct. 16, 2008

(54) Display Using a Three-Dimensional vision System

(76) Inventors: Matthew Bell, San Francisco, CA (US); Matthew Vieta, Mountain View, CA (US); Raymond Chin, Santa Clara, CA (US); Malik Coates, San Francisco, CA (US); Steven Fink, San Carlos, CA (US)

Correspondence Address: CARR & FERRELL LLP, 2200 GENG ROAD, PALO ALTO, CA, 94303, US

(21) Appl. No.: 12/100,737

(22) Filed: Apr. 10, 2008

Related U.S. Application Data
(60) Provisional application No. 60/922,873, filed on Apr. 10, 2007.

(51) Int. Cl. G09G 5/00

(52) U.S. Cl. 345/156

(57) ABSTRACT

An interactive video display system allows a physical object to interact with a virtual object. A light source delivers a pattern of invisible light to a three-dimensional space occupied by the physical object. A camera detects invisible light scattered by the physical object. A computer system analyzes information generated by the camera, maps the position of the physical object in the three-dimensional space, and generates a responsive image that includes the virtual object. A display presents the responsive image.

### CROSS-REFERENCE TO RELATED APPLICATION

The present application claims the priority benefit of U.S. provisional patent application No. 60/922,873 filed Apr. 10, 2007 and entitled “Display Using a Three-Dimensional Vision System,” the disclosure of which is incorporated herein by reference.

### BACKGROUND

1. Field of the Invention

The present invention generally relates to interactive media. More specifically, the present invention relates to providing a display using a three-dimensional vision system.

2. Background Art

Traditionally, human interaction with video display systems has required users to employ devices such as hand-held remote controls, keyboards, mice, and joystick controls. An interactive video display system allows real-time, human interaction with images generated and displayed by the system without employing such devices.

While existing interactive video display systems allow real-time, human interactions, such displays are limited in many ways. In one example, the existing interactive video systems require specialized hardware to be held by the users. The specialized hardware may be inconvenient and prone to damage or loss. Further, the specialized hardware may require frequent battery replacement. Specialized hardware, too, may provide a limited number of points to be tracked by the existing interactive video systems, thus limiting the usefulness and reliability in interacting with the entire body of a user or with multiple users.

In another example, the existing interactive video systems are camera-based, such as the EyeToy® from Sony Computer Entertainment Inc. Certain existing camera-based interactive video systems may be limited in the range of motions of the user that can be tracked. Additionally, some camera-based systems only allow for body parts that are moving to be tracked rather than the entire body. In some instances, distance information may not be detected (i.e., the system may not provide for depth perception).

### SUMMARY OF THE CLAIMED INVENTION

An interactive video display system allows a physical object to interact with a virtual object. A light source delivers a pattern of invisible light to a three-dimensional space occupied by the physical object. A camera detects invisible light scattered by the physical object. A computer system analyzes information generated by the camera, maps the position of the physical object in the three-dimensional space, and generates a responsive image that includes the virtual object. A display presents the responsive image.

### BRIEF DESCRIPTION OF THE DRAWINGS

FIG. 1 illustrates an exemplary embodiment of an interactive video display system that allows a physical object to interact with a virtual object.

FIG. 2 illustrates an exemplary embodiment of a light source in the video display system of FIG. 1.

FIG. 3 illustrates another exemplary embodiment of the light source of FIGURE.

FIG. 4 illustrates yet another exemplary embodiment of the light source of FIG. 1.

FIG. 5 illustrates various exemplary form factors of the interactive video display system.

FIG. 6 illustrates an exemplary form factor of the interactive video display system that may accommodate multiple users.

FIG. 7 illustrates various exemplary form factors of the interactive video display system in which the light source is positioned above the users.

FIG. 8 illustrates an exemplary mapping between the physical space and the virtual space in cross-section.

FIG. 9 illustrates another exemplary mapping between the physical space and the virtual space in cross-section.

FIG. 10 illustrates an exemplary embodiment of the interactive video display system having multiple interactive regions in the physical space.

FIG. 11 illustrates an exemplary embodiment of the interactive video display system in which two users separately interact with two displays and share the virtual space.

### DETAILED DESCRIPTION

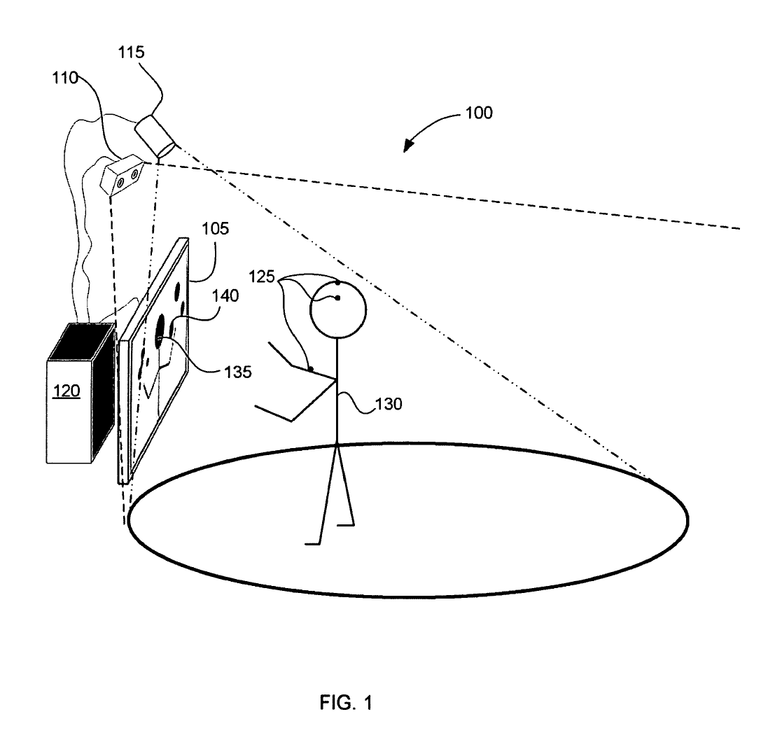

FIG. 1 illustrates an exemplary embodiment of an interactive video display system 100 that allows a physical object to interact with a virtual object. The interactive video display system 100 of FIG. 1 includes a display 105 and a three-dimensional (3D) vision system 110. The interactive video display system 100 may further include a light source 115 and a computing device 120. The interactive video display system 100 may be configured in a variety of form factors.

The display 105 may include a variety of components. The display 105 may be a flat panel display such as a liquid-crystal display (LCD), a plasma screen, an organic light emitting diode (OLED) display screen, or other display that is flat. The display 105 may include a cathode ray tube (CRT), an electronic ink screen, a rear projection display, a front projection display, an off-axis front (or rear) projector (e.g., the WT600 projector sold by NEC), a screen that produces a 3D image (e.g., a lenticular 3D video screen), or a fogscreen. (e.g., the Heliodisplay™ screen made by 102 technologies). The display 105 may include multiple screens or monitors that may be tiled to form a single larger display. The display 105 may be non-planar (e.g., cylindrical or spherical).

The 3D vision system 110 may include a stereo vision system to combine information generated from two or more cameras (e.g., a stereo camera) to construct a three-dimensional image. The functionality of the stereo vision system may be analogous to depth perception in humans resulting from binocular vision. The stereo vision system may input two or more images of the same physical object taken from slightly different angles into the computing device 120.

The computing device 120 may process the inputted images using techniques that implement stereo algorithms such as the Marr-Poggio algorithm. The stereo algorithms may be utilized to locate features such as texture patches from corresponding images of the physical object acquired simultaneously at slightly different angles by the stereo vision system. The located texture patches may correspond to the same part of the physical object. The disparity between the positions of the texture patches in the images may allow the distance from the camera to the part of the physical object that corresponds to the texture patch to be determined by the computing device 120. The texture patch may be assigned position information in three dimensions.

Some examples of commercially available stereo vision systems include the Tyzx DeepSea™ and the Point Grey Bumblebee™. The stereo vision systems may include cameras that are monochromatic (e.g., black and white) or polychromatic (e.g., “color”). The cameras may be sensitive to one or more specific bands of the electromagnetic spectrum, including visible light (i.e., light having wavelengths approximately within the range from 400 nanometers to 700 nanometers), infrared light (i.e., light having wavelengths approximately within the range from 700 nanometers to 1 millimeter), and ultraviolet light (i.e., light having wavelengths approximately within the range from 10 nanometers to 400 nanometers).

Texture patches may act as “landmarks” used by the computing device implemented stereo algorithm to correlate two or more images. The reliability of the stereo algorithm may therefore be reduced when applied to images of physical objects having large areas of uniformities such as color and texture. The reliability of the stereo algorithm-specifically distance determinations—may be enhanced, however, by illuminating a physical object being imaged by the stereo vision system with a pattern of light. The pattern of light may be supplied by a light source such as the light source 115.

The 3D vision system 110 may include a time-of-flight camera capable of obtaining distance information for each pixel of an acquired image. The distance information for each pixel may correspond to the distance from the time-of-flight camera to the object imaged by that pixel. The time-of-flight camera may obtain the distance information by measuring the time required for a pulse of light to travel from a light source proximate to the time-of-flight camera to the object being imaged and back to the time-of-flight camera. The light source may repeatedly emit light pulses allowing the time-of-flight camera to have a frame-rate similar to a standard video camera. For example, the time-of-flight camera may have a distance range of approximately 1-2 meters at 30 frames per second. The distance range may be increased by reducing the frame-rate and increasing the exposure time. Commercially available time-of-flight cameras include those available from manufacturers such as Canesta Inc. of Sunnyvale, Calif. and 3DV Systems of Israel.

The 3D vision system 110 may also include one or more of a laser rangefinder, a camera paired with a structured light projector, a laser scanner, a laser line scanner, an ultrasonic imager, or a system capable of obtaining three-dimensional information based on the intersection of foreground images from multiple cameras. Any number of 3D vision systems, which may be similar to 3D vision system 110, may be simultaneously used. Information generated by the several 3D vision systems may be merged to create a unified data set.

The light source 115 may deliver light to the physical space imaged by the 3D vision system 110. Light source 115 may include a light source that emits visible and/or invisible light (e.g., infrared light). The light source 115 may include an optical filter such as an absorptive filter, a dichroic filter, a monochromatic filter, an infrared filter, an ultraviolet filter, a neutral density filter, a long-pass filter, a short-pass filter, a band-pass filter, or a polarizer. Light source 115 may rapidly be turned on and off to effectuate a strobing effect. The light source 115 may be synchronized with the 3D vision system 110 via a wired or wireless connection.

Light source 115 may deliver a pattern of light to the physical space that is imaged by the 3D vision system 110. A variety of patterns may be used in the pattern of light. The pattern of light may improve the prominence of the texture patterns in images acquired by the 3D vision system 110, thus increasing the reliability of the stereo algorithms applied to the images by the computing device 120. The pattern of light may be invisible to users (e.g., infrared light). A pattern of invisible light may allow the interactive video display system 100 to operate under any lighting conditions in the visible spectrum including complete or near darkness. The light source 115 may illuminate the physical space being imaged by the 3D vision system 110 with un-patterned visible light when background illumination is insufficient for the user's comfort or preference.

The light source 115 may include concentrated light sources such as high-power light-emitting diodes (LEDs), incandescent bulbs, halogen bulbs, metal halide bulbs, or arc lamps. A number of concentrated light sources may be simultaneously used. Any number of concentrated light sources may be grouped together or spatially dispersed. A substantially collimated light source (e.g., a lamp with a parabolic reflector and one or more narrow angle LEDs) may be included in the light source 115.

Various patterns of light may be used to provide prominent texture patches to the physical object being imaged by the 3D vision system 110; for example, a random dot pattern. Other examples include a fractal noise pattern that provides noise on varying length scales or a set of parallel lines that are separated by randomly varying distances.

The patterns in the pattern of light may be generated by the light source 115, which may include a video projector. The video projectors may be designed to project an image that is provided via a video input cable or some other input mechanism. The projected image may change over time to facilitate the performance of the 3D vision system 110. In one example, the projected image may dim in an area that corresponds to a part of the image acquired by the 3D vision system 110 that is becoming saturated. In another example, the projected image may exhibit higher resolution in those areas where the physical object is close to the 3D vision system 110. Any number of video projectors may simultaneously be used.

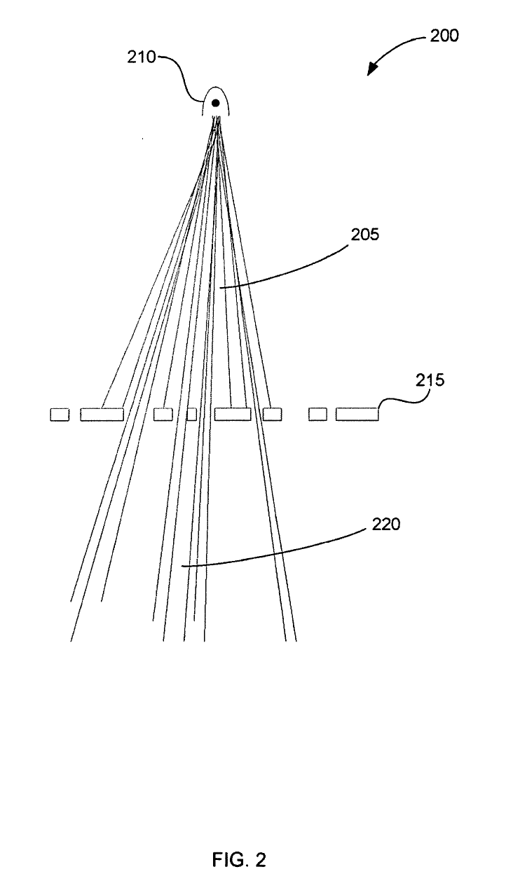

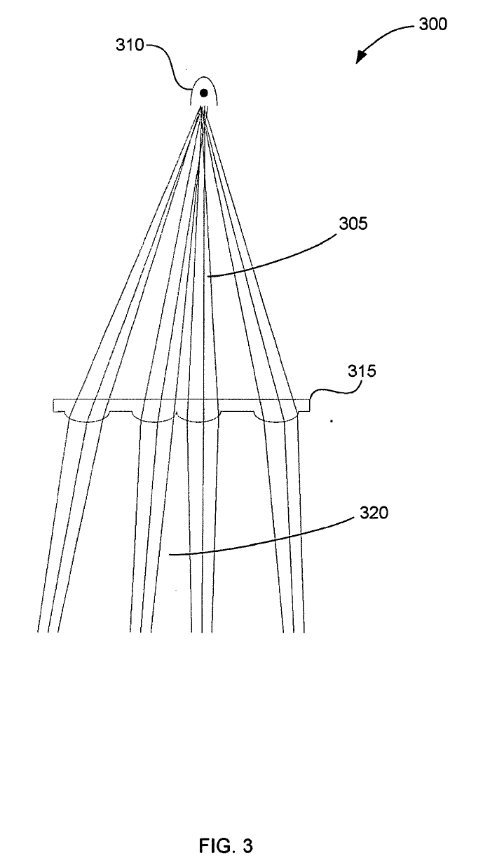

FIG. 2 illustrates an exemplary embodiment 200 of the light source 115. In the embodiment 200, light rays 205 emitted from a concentrated light source 210 are passed through an optically opaque film 215 that contains a pattern. An uneven pattern of light 220 may be delivered to the physical space imaged by the 3D vision system 110. The pattern of light may be generated by a slide projector. The optically opaque film 215 may be replaced by a transparent slide containing an image.

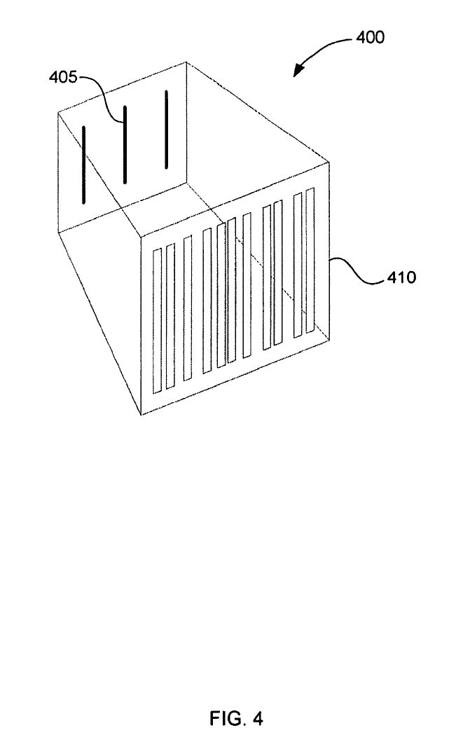

FIG. 3 illustrates another exemplary embodiment 300 of the light source 115. The pattern of light may be generated by the embodiment 300 of FIG. 3 in a similar fashion similar to that described with respect to FIG. 2. In the embodiment 300 of FIG. 3, a surface 315 that contains a number of lenses redirects light rays 305 creating an uneven pattern of light 320. The surface 315 may include a plurality of Fresnel lenses, any number of prisms, a transparent material with a undulated surface, a multi-faceted mirror (e.g., a disco ball), or another optical element to redirect the light rays 305 to create a pattern of light.

Light source 115 may include a structured light projector. The structured light projector may cast out a static or dynamic pattern of light. Examples of a structured light projector include the LCD-640™ and the MiniRot-H1™ that are both available from ABW.

FIG. 4 illustrates yet another exemplary embodiment 400 of the light source 115. A pattern of light that includes parallel lines of light may be generated by the embodiment 400 in a similar fashion as embodiment 200 described with respect to FIG. 2. In the embodiment 400 of FIG. 4, at least one linear light source 405 emits light rays that pass through an opaque surface 410 that contains a set of linear slits. The at least one linear light source 405 may include a fluorescent tube, a line or strip of LEDs, or another light source that is substantially one-dimensional. The set of linear slits contained by the opaque surface 410 may be replaced by long prisms, cylindrical lenses, or multi-faceted mirror strips.

Computing device 120 in FIG. 1 analyzes information generated by the 3D vision system 110. Analysis may include calculations to extract or determine position information of the physical object imaged by the 3D vision system 110. The position information may include a set of points (e.g., points 125 as illustrated in FIG. 1) where each point has a defined position in three dimensions. The set of points may correspond to a surface of a physical object within the physical space being imaged by the 3D vision system 110. The physical object may be a body, a hand, or a fingertip of a user 130 as illustrated in FIG. 1. The physical object may also be an inanimate object (e.g., a ball). The computing device 120 may, in some embodiments, be integrated with the 3D vision system 110 as a single system.

The analysis performed by the computing device 120 may further include coordinate transformation (e.g., mapping) between position information in physical space and position information in virtual space. The position information in virtual space may be confined by predefined boundaries. In one example, the predefined boundaries are established to encompass only the portion of the virtual space presented by the display 105, such that the computing device 120 may avoid performing analyses on position information in the virtual space that will not be presented. The analysis may refine the position information by removing portions of the position information that are located outside a predefined space, smoothing noise in the position information, and removing spurious points in the position information.

The computing device 120 may create and/or generate virtual objects that do not necessarily correspond to the physical objects imaged by the 3D vision system 110. For example, user 130 of FIG. 1 may interact with a “virtual bail” even though the ball does not correspond to any actual, physical object in the physical, real-world space imaged by the 3D vision system 110. The computing device 120 may calculate interactions between the user 130 and the virtual ball using the position information in physical space of the user 130 mapped to virtual space in conjunction with the position information in virtual space of the virtual ball. An image or video may be presented to the user 130 by the display 105 in which a virtual user representation of the body or body part of the user 130 (e.g., a virtual user representation 135) is shown interacting with the virtual ball (e.g., a virtual ball 140). The responsive image presented to the user 130 may provide feedback about the position of the virtual objects relative to the virtual user representation 135 such as movement in the virtual ball in response to the user 130 interaction with the same.

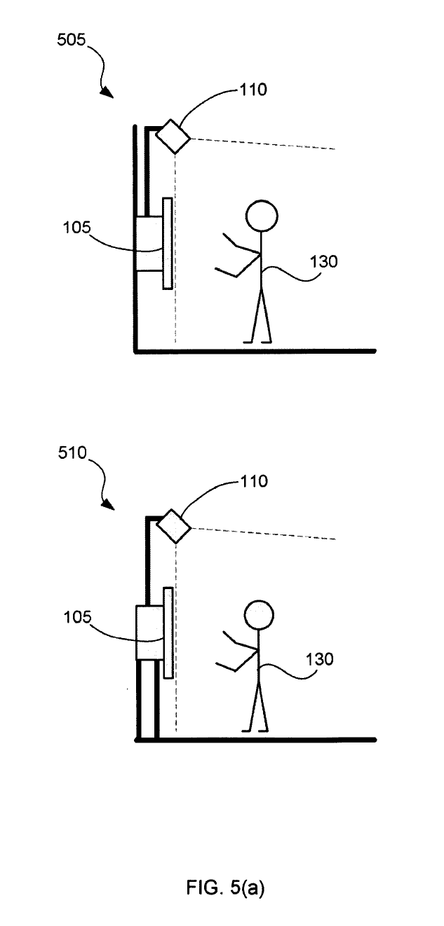

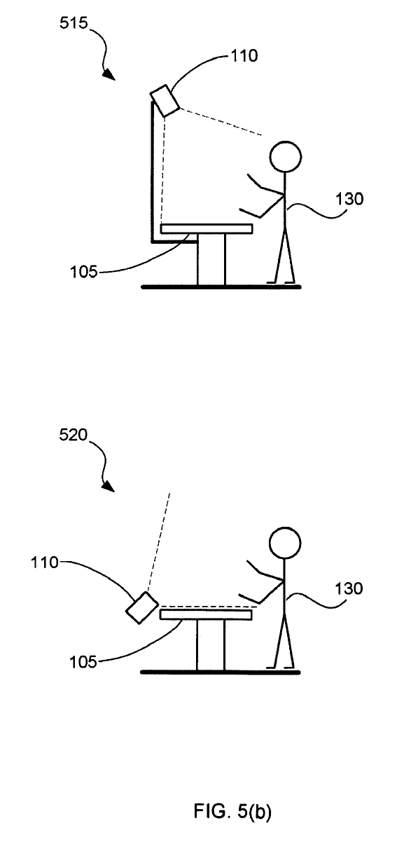

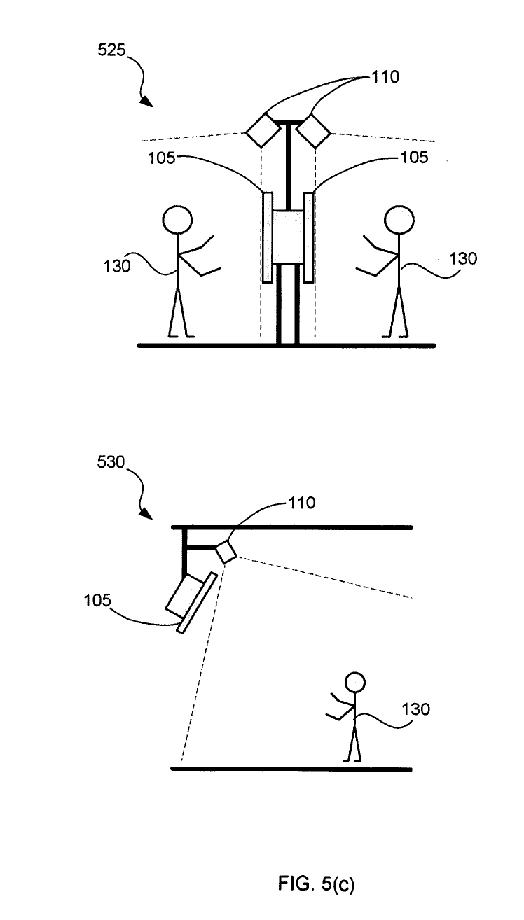

FIG. 5 illustrates various exemplary form factors 505-530 of the interactive video display system. For ease of illustration, the light source 15 is not shown. It should otherwise be understood that the light source 115 may be included in each of the form factors illustrated in FIG. 5. Multiple users may interact in form factors 505-530. In the form factor 505 shown in FIG. 5(a), elements of the interactive video display system 100 including display 105 and 3D vision system 110 are mounted to a wall. In the form factor 510 shown in FIG. 5(a), the elements of the interactive video display system 100 are freestanding and may include a large base or otherwise be secured to the ground. Furthermore, elements of the interactive video display system 100 including the 3D vision system 110 and the light source 115 may be attached to display 105.

In the form factor 515 as illustrated in FIG. 5(b), the display 105 is be oriented horizontally such that the user 130 may view the display 105 like a tabletop. The 3D vision system 110 in the form factor 515 is oriented substantially downward. In the form factor 520 shown in FIG. 5(b), the display 105 is oriented horizontally, similar to the display 105 in the form factor 515 and the 3D vision system 110 is oriented substantially upward.

In the form factor 525 shown in FIG. 5(c), two displays, each display being similar to the display 105, are positioned adjacently, but oppositely oriented (i.e., back-to-back). Each of the two displays may be viewable by the users 130. In the form factor 530 shown in FIG. 5(c), the elements of the interactive video display system 100 are mounted to a ceiling.

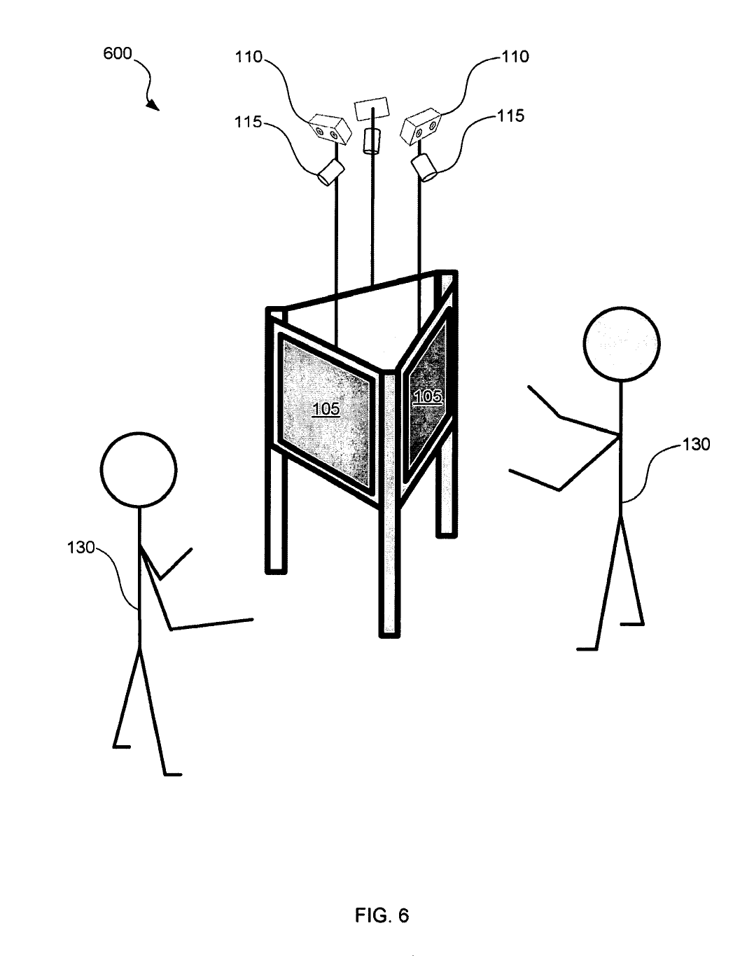

FIG. 6 illustrates an exemplary form factor 600 of the interactive video display system that may accommodate multiple users 130. The interactive video display system 100 may include multiple displays 105, each display having a corresponding 3D vision system 110 and light source 115. According to some embodiments, the light source 115 may be omitted. The displays 105 may be mounted to a table, frame, wall, ceiling, etc., as discussed herein. In the form factor 600, three of the displays 105 are mounted to a freestanding frame that is accessible by the users 130 from all sides.

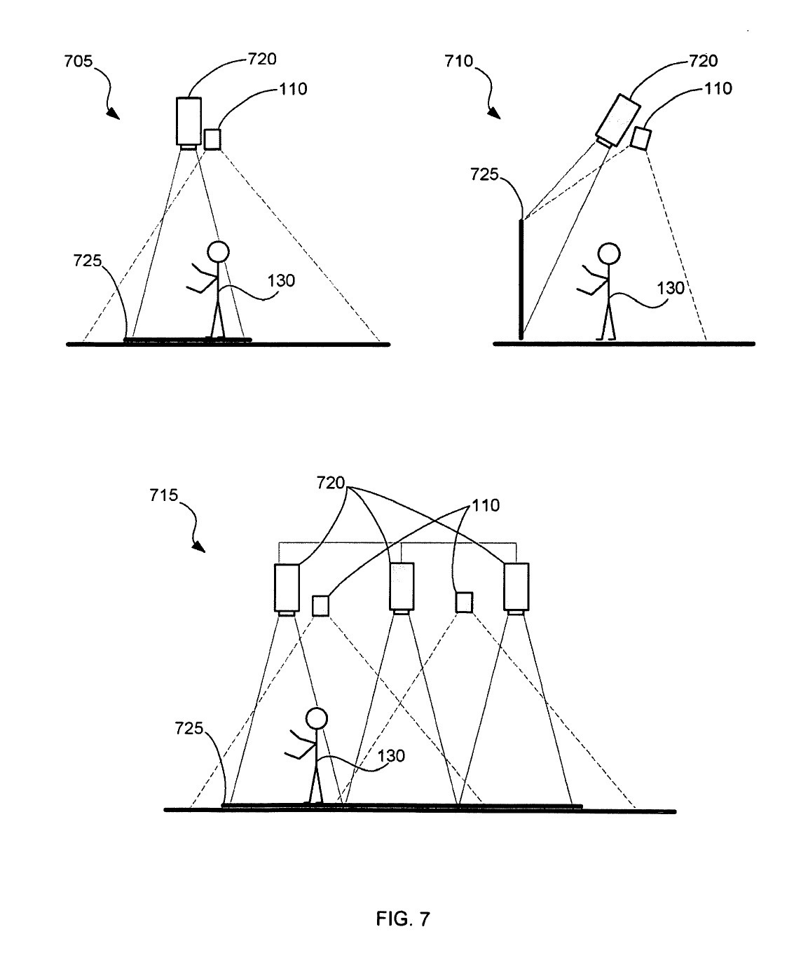

FIG. 7 illustrates various exemplary form factors 705-715 of the interactive video display system in which a projector 720 is positioned above the user 130. The projector 720 may create a visible light image. In the form factor 705, the projector 720 and the 3D vision system 110 are mounted to the ceiling, both directed substantially downward. The projector 720 may cast an image on the ground or on a screen 725. In some embodiments, the user 130 may walk on the screen 725. In the form factor 710, the projector 720 and the 3D vision system 110 are mounted to the ceiling. The projector 720 may cast an image on a wall or on the screen 725. The screen 725 may be mounted to the wall. In form factor 715, multiple projectors 720 and multiple 3D vision systems 110 are mounted to the ceiling.

The 3D vision system 110 and/or the light source 115 may be mounted to a monitor of a laptop computer. The monitor may replace the display 105 in such an embodiment while the laptop computer may replace the computing device 120 as otherwise illustrated in FIG. 1. Such an embodiment would allow the interactive video display system 100 to become portable.

The interactive video display system 100 may further include audio components such as a microphone and/or a speaker. The audio components may enhance the user's interaction with the virtual space by supplying, for example, music or sound-effects that are correlated to certain interactions. The audio components may also facilitate verbal communication with other users. The microphone may be directional to better capture audio from specific users without excessive background noise. In another example, the speaker may be directional to focus audio onto specific users and specific areas. A directional speaker may be commercially available from manufacturers, such as Brown Innovations (e.g., the Maestro™ and the SoloSphere™), Dakota Audio, Holosonics, and the American Technology Corporation of San Diego (ATCSD).

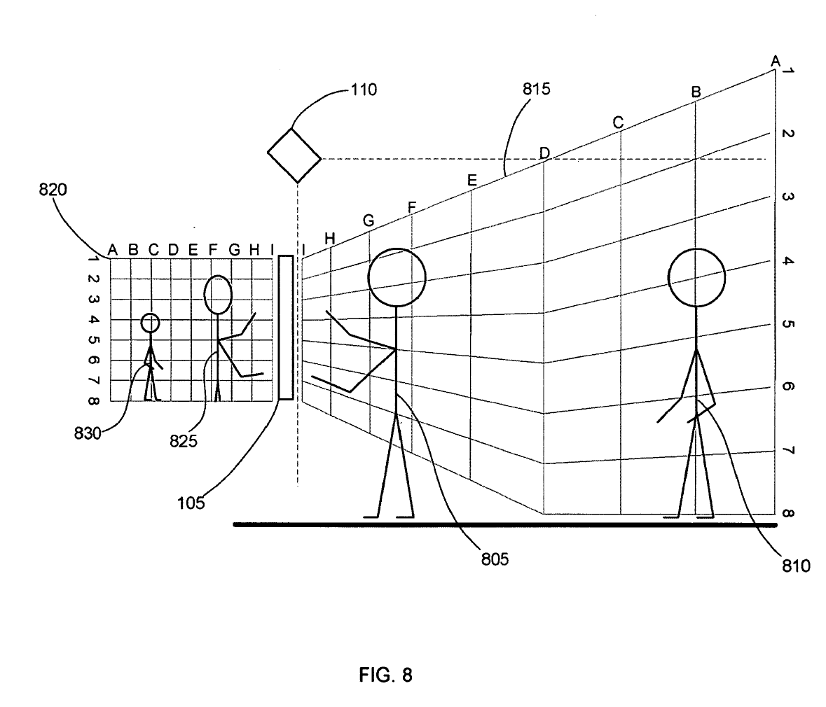

FIG. 8 illustrates an exemplary mapping between the physical space and the virtual space in cross-section. A coordinate system may be arbitrarily assigned to the physical space and/or the virtual space. In FIG. 8, users 805 and 810 are standing in front of the display 105. The 3D vision system 110 detects position information of the users 805 and 810 in three dimensional space. The position information of the users 805 and 810 may correspond to points within a coordinate space grid 815 in the physical space. The coordinate space grid 815 may be mapped to a coordinate space grid 820 in the virtual space by the computing device 120. For example, a point on the coordinate space grid 815 that is occupied by the user 805 (e.g., the point at G3 on the coordinate space grid 815) may be mapped to a point on the coordinate space grid 820 that is occupied by a virtual user representation 825 of the user 805 (e.g., the point at G3 on the coordinate space grid 820).

The virtual space, which may be defined in part by the coordinate space grid 820, may be presented to the users 805 and 810 on the display 105. The virtual space may appear to the users 805 and 810 as if the objects in the virtual space (e.g., the virtual user representations 825 and 830 of the users 805 and 810, respectively) are behind the display 105. In some embodiments, such as that shown in FIG. 8, the apparent size of a user (e.g., the users 805 and 810) may decrease as the user moves further from the display 105 because the coordinate space grid 815 is skewed (i.e., spreads out further from the display 105). A skewed coordinate space grid (e.g., coordinate space grid 815) may accommodate an increased number of users at further distances from the display 105 since the cross-sectional area of the skewed coordinate space grid increases at further distances. The skewed coordinate space grid also may ensure that a virtual user representation of a user that is closer to the display 105 (e.g., the virtual user representation 825 of the user 805) appears larger, thus more important, than a virtual user representation of a user further from the display 105 (e.g., the virtual user representation 830 of the user 810).

Additionally, the coordinate space grid 815 may not intersect the surface on which the users 805 and 810 are positioned. This may ensure that the feet of the virtual user representations of the users do not appear above a virtual floor. The virtual floor may be perceived by the users as the bottom of the display.

The virtual space observed by the users 805 and 810 may vary based on which type of display is chosen. The display 105 may be capable of presenting images such that the images appear three-dimensional to the users 805 and 810. The users 805 and 810 may perceive the virtual space as a three-dimensional environment. Users may determine three-dimensional position information of the respective virtual user representations 825 and 830 as well as that of other virtual objects. The display 105 may, in some instances, not be capable of portraying three-dimensional position information to the users 805 and 810, in which case the depth component of the virtual user representations 825 and 830 may be ignored or rendered into a two-dimensional image.

Mapping may be performed between the coordinate space grid 815 in the physical space to the coordinate space grid 820 in the virtual space such that the display 105 behaves similar to a mirror as perceived by the users 805 and 810. Motions of the virtual user representation 825 may be presented as mirrored motions of the user 805. The mapping may be calibrated such that, when the user 805 touches or approaches the display 105, the virtual user representation 825 touches or approaches the same part of the display 105. Alternatively, the mapping may be performed such that the virtual user representation 825 may appear to recede from the display 105 as the user 805 approaches the display 105. The user 805 may perceive the virtual user representation 825 as facing away from the user 805.

The coordinate system may be assigned arbitrarily to the physical space and/or the virtual space, which may provide for various interactive experiences. In one such interactive experience, the relative sizes of two virtual user representations may be altered compared to the relative sizes of two users in that the taller user may be represented by the shorter virtual user representation. A coordinate space grid in the physical space may be orthogonal, thus not skewed as illustrated by the coordinate space grid 815 in FIG. 8. An orthogonal coordinate space grid in physical space may result in virtual user representations appearing the same or similar size, even when the virtual user representations correspond to users at varying distances from the display 105.

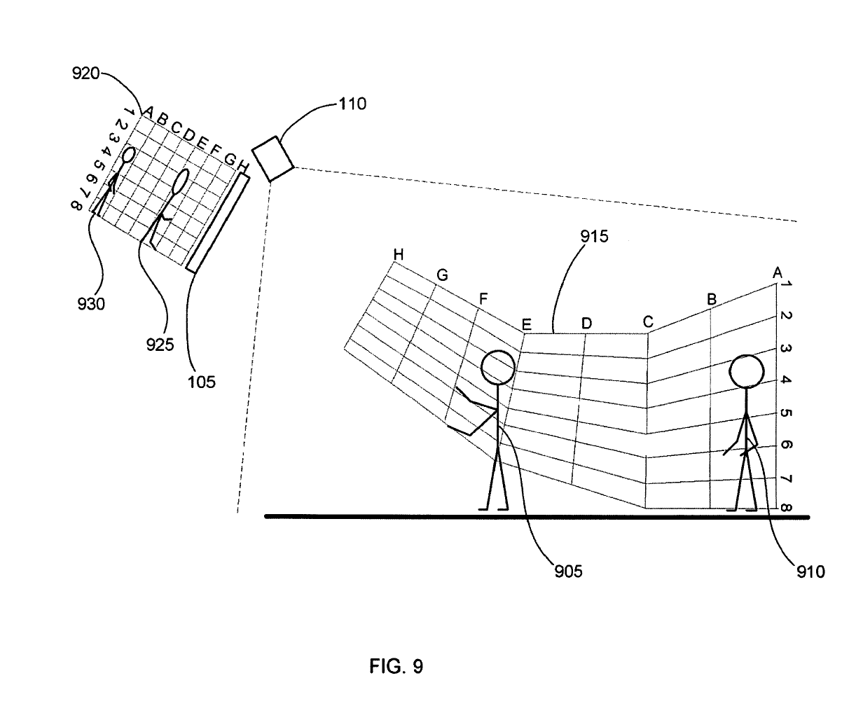

FIG. 9 illustrates another exemplary mapping between the physical space and the virtual space in cross-section. The coordinate system assigned to the physical space may be adjusted to compensate for interface issues that may arise, for example, when the display 105 is mounted on the ceiling or otherwise out of reach of the users. In FIG. 9, position information of users 905 and 910 may be detected by the 3D vision system 110 in three-dimensions. The position information of the users 905 and 910 may correspond to points within a coordinate space grid 915 in the physical space. The coordinate space grid 915 may be mapped to a coordinate space grid 920 in the virtual space. Virtual user representations 925 and 930 of the users 905 and 910, respectively, may be presented on the display 105. The coordinate space grid 915 may allow virtual user representations (e.g., the virtual user representation 930) of distant users (e.g., the user 910) to increase in size on the display 105 as the distant users approach the screen. The coordinate space grid 915 may allow virtual user representations (e.g., the virtual user representation 925) to disappear off the bottom of the display 105 as users (e.g., the user 905) pass under the display 105.

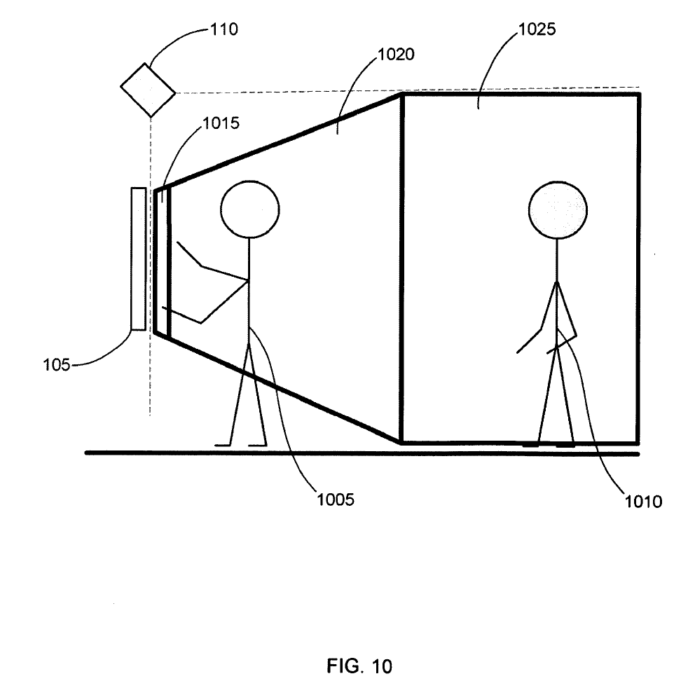

FIG. 10 illustrates an exemplary embodiment of the interactive video display system having multiple interactive regions, or “zones,” in the physical space. Position information of users 1005 and 1010 may be detected by the 3D vision system 110 in three dimensions. The physical space may be partitioned into a plurality of interactive regions whereby different types of user interactions (e.g., selecting, deselecting, and moving virtual objects) may occur in each of the plurality of interactive regions. In the example illustrated in FIG. 10, the physical space is partitioned into a touch region 1015, a primary users region 1020, and a distant users region 1025. Portions of the position information may be sorted by the computing device 120 according to the region that is occupied by the user, or part of the user, that corresponds to the portions of the position information.

In FIG. 10, a hand of the user 1005 occupies the touch region 1015 while the rest of the user 1005 occupies the primary users region 1020. The user 1010 occupies the distant user region 1025. A virtual user representation presented to the user 1005 on the display 105 may vary depending on what region is occupied by the user 1005. In one example, fingers or hands of the user 1005 in the touch region 1015 may be represented by cursers, the body of the user 1005 in the primary user region 1020 may be represented by colored outlines, and the body of the user 1010 in the distant users region 1025 may be represented by grey outlines. The boundaries of the partitioned regions, too, may change. In one example, if the primary users region 1020 is unoccupied, the boundary defining the primary users region 1020 may shift to include the distant users region 1025. Users beyond a predefined distance from the display 105 may have reduced or eliminated ability to interact with virtual objects presented by the display 105 allowing users near the display 105 to interact with the virtual objects without interference from more distant users.

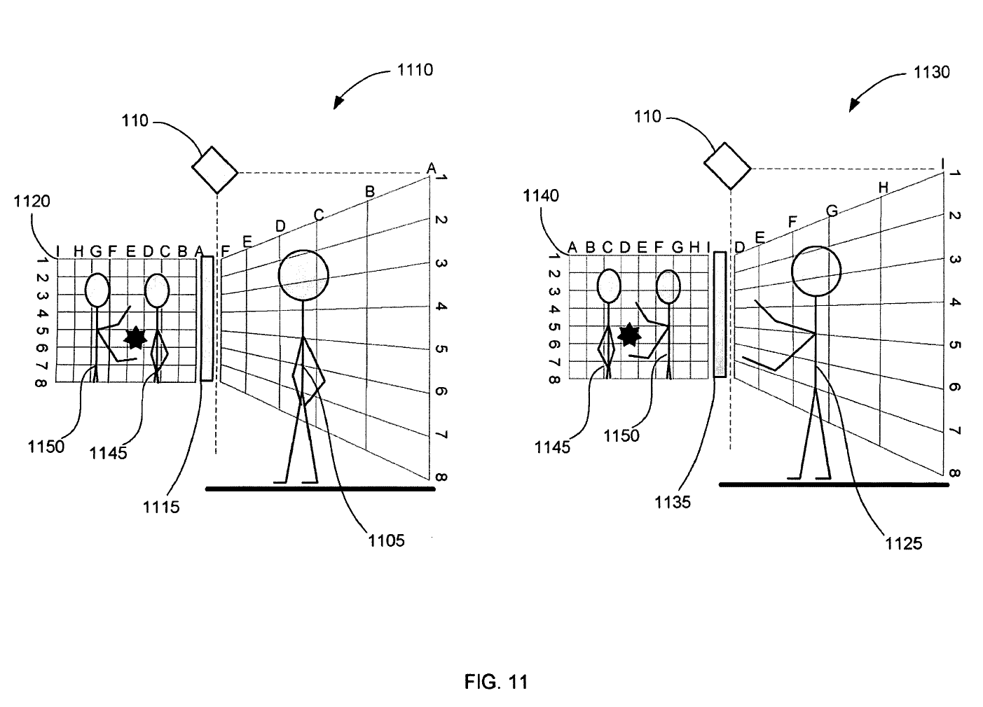

Information (including a responsive image or data related thereto) from one or more interactive video display systems, each similar to the interactive video display system 100, may be shared over a network or a high-speed data connection. FIG. 11 illustrates the interactive video display system configured to allow two users separately interact with two displays and share the virtual space. Position information of a user 1105 is detected by the 3D vision system 110 of an interactive video display system 1110. The interactive video display system 1110 at least includes a display 1115 that presents a virtual space defined by a coordinate space grid 1120 to the user 1105. Likewise, position information of a user 1125 may be detected by the 3D vision system 110 of an interactive video display system 1130. The interactive video display system 1130 at least includes a display 1135 that presents a virtual space defined by a coordinate space grid 1140 to the user 1125. The coordinate space grids 1120 and 1140 may be synchronized, such as via the high-speed data connection. Synchronizing the coordinate space grids 1120 and 1140 may allow the virtual user representations 1145 and 1150 of both of the users 1105 and 1125, respectively, to be presented on both of the displays 1115 and 1135. The virtual user representations 1145 and 1150 may be capable of interacting thereby giving the users 1105 and 1125 the sensation of interacting with each other in the virtual space. As discussed herein, the use of microphones and speakers may enable or enhance verbal communication between the users 1105 and 1125.

The principles illustrated by FIG. 11 may be extended to include any number of users in any number of locations. The interactive video display system 100 may enable users to participate in online games (e.g., Second Life, There, and World of Warcraft). In another example, a multiuser workspace is facilitated in which groups of users may move and manipulate data represented on the display in a collaborative manner.

Many applications of the interactive video display system 100 exist involving various types of interactions. Additionally, a variety of virtual objects, other than virtual user representations, may be presented by a display, such as the display 105. Two-dimensional force-based interactions and influence-image-based interactions are described in U.S. Pat. No. 7,259,747 entitled “Interactive Video Display System,” filed May 28, 2002, which is hereby incorporated by reference.

Two-dimensional force-based interactions and influence-image-based interactions may be extended to three dimensions. Thus, the position information in three dimensions of a user may be used to generate a three-dimensional influence-image to affect the motion of a three-dimensional object. These interactions, in both two dimensions and three dimensions, allow the strength and direction of a force imparted by the user on a virtual object to be computed, giving the user control over how the motion of the virtual object affected.

Users may interact with the virtual objects by intersecting with the virtual objects in the virtual space. The intersection may be calculated in three dimensions. Alternatively, the position information in three dimensions of the user may be projected to two dimensions and calculated as a two-dimensional intersection.

Visual effects may be generated based at least on the position information in three dimensions of the user. In some examples, a glow, a warping, an emission of particles, a flame trail, or other visual effects may be generated using the position information in three dimensions of the user or of a portion of the user. The visual effects may be based on the position of specific body parts of the user. For example, the user may create virtual fireballs by bringing the hands of the user together.

The users may use specific gestures (e.g., pointing, waving, grasping, pushing, grabbing, dragging and dropping, poking, drawing shapes using a finger, and pinching) to pick up, drop, move, rotate, or manipulate otherwise the virtual objects presented on the display. This feature may allow for many applications. In one example, the user may participate in a sports simulation in which the user may box, play tennis (using a virtual or physical racket), throw virtual balls, etc. The user may engage in the sports simulation with other users and/or virtual participants. In another example, the user may navigate virtual environments in which the user may use natural body motions (e.g., leaning) to move about in the virtual environments.

The user may, in some instances, interact with virtual characters. In one example, the virtual character presented on the display may talk, play, and otherwise interact with users as they pass by the display. The virtual character may be computer controlled or may be controlled by a human at a remote location.

The interactive video display system 100 may be used in a wide variety of advertising applications. Some examples of the advertising applications may include interactive product demonstrations and interactive brand experiences. In one example, the user may virtually try on clothes by dressing the virtual user representation of the user.

The elements, components, and functions described herein may be comprised of instructions that are stored on a computer-readable storage medium. The instructions may be retrieved and executed by a processor (e.g., a processor included in the computing device 120). Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage media.

Software may perform a variety of tasks to improve the usefulness of the interactive video display system 100. In embodiments where multiple 3D vision systems (e.g., the 3D vision system 110) are used, the position information may be merged by the software into one coordinate system (e.g., coordinate space grids 1120 and 1140). In one example, one of the multiple 3D vision systems may focus on the physical space near to the display while another of the multiple 3D vision systems may focus on the physical space far from the display. Alternately, the two of the multiple 3D vision systems may cover a similar portion of the physical space from two different angles.

In embodiments in which the 3D vision system 110 includes the stereo camera discussed herein, the quality and resolution of the position information generated by the stereo camera may be processed variably. In one example, the portion of the physical space that is closest to the display may be processed at a higher resolution in order to resolve individual fingers of the user. Resolving the individual fingers may increase accuracy for various gestural interactions.

Several methods, which may be described by the software, may be used to remove portions of the position information (e.g., inaccuracies, spurious points, and noise). In one example, background methods may be used to mask out the position information from areas of the 3D vision system 110 field of view that are known to have not moved for a particular period of time. The background methods (also referred to as background subtraction methods) may be adaptive, allowing the background methods to adjust to changes in the position information over time. The background methods may use luminance, chrominance, and/or distance data generated by the 3D vision system 110 in order to distinguish a foreground from a background. Once the foreground is determined, the position information gathered from outside the foreground region may be removed. In another example, noise filtering methods may be applied directly to the position information or be applied as the position information is generated by the 3D vision system 110. The noise filtering methods may include smoothing and averaging techniques (e.g., median filtering). A mentioned herein, spurious points (e.g., isolated points and small clusters of points) may be removed from the position information when, for example, the spurious points do not correspond to a virtual object. In one embodiment, in which the 3D vision system 110 includes a color camera, chrominance information may be obtained of the user and other physical objects. The chrominance information may be used to provide a color, three-dimensional virtual user representation that portrays the likeness of the user. The color, three-dimensional virtual user representation may be recognized, tracked, and/or displayed on the display.

The position information may be analyzed with a variety of methods. The analysis may be directed by the software. Physical objects, such as body parts of the user (e.g., fingertips, fingers, and hands), may be identified in the position information. Various methods for identifying the physical objects may include shape recognition and object recognition algorithms. The physical objects may be segmented using any combination of two/three-dimensional spatial, temporal, chrominance, or luminance information. Furthermore, the physical objects may be segmented under various linear or non-linear transformations of information, such as two/three-dimensional spatial, temporal, chrominance, or luminance information. Some examples of the object recognition algorithms may include deformable template matching, Hough transforms, and algorithms that aggregate spatially contiguous pixels/voxels in an appropriately transformed space.

The position information of the user may be clustered and labeled by the software, such that the cluster of points corresponding to the user is identified. Additionally, the body parts of the user (e.g., the head and the arms) may be segmented as markers. The position information may be dustered using unsupervised methods such as k-means and hierarchical dustering. A feature extraction routine and a feature classification routine may be applied to the position information. The feature extraction routine and the feature classification routine are not limited to use with the position information and may also be applied to any previous feature extraction or feature classification in any of the information generated.

A virtual skeletal model may be mapped to the position information of the user. The virtual skeletal model may be mapped via a variety of methods that may include expectation maximization, gradient descent, particle filtering, and feature tracking. Additionally, face recognition algorithms (e.g., eigenface and fisherface) may be applied to the information generated by the 3D vision system 110 in order to identify a specific user and/or facial expressions of the user. The facial recognition algorithms may be applied to image-based or video-based information. Characteristic information about the user (e.g., face, gender, identity, race, and facial expression) may be determined and affect content presented by the display.

The 3D vision system 110 may be specially configured to detect certain physical objects other than the user. In one example, RFID tags attach to the physical objects may be detected by a RFID reader to provide or generate position information of the physical objects. In another example a light source attached to the object may blink in a specific patter to provide identifying information to the 3D vision system 110.

As mentioned herein, the virtual user representation may be presented by a display (e.g., the display 105) in a variety of ways. The virtual user representation may be useful in allowing the user to interact with the virtual objects presented by the display. In one example, the virtual user representation may mimic a shadow of the user. The shadow may represent a projection onto a flat surface of the position information of the user in 3D.

In a similar example, the virtual user representation may include an outline of the user, such as may be defined by the edges of the shadow. The virtual user representation, as well as other virtual objects, may be colored, highlighted, rendered, or otherwise processed arbitrarily before being presented by the display. Images, icons, or other virtual renderings may represent the hands or other body parts of the users. A virtual representation of, for example, the hand of the user may only appear on the display under certain conditions (e.g., when the hand is pointed at the display). Features may be added to the virtual user representation that does not necessarily correspond to the user. In one example, a virtual helmet may be included in the virtual user representation of a user not wearing a physical helmet.

The virtual user representation may change appearance based on the user's interactions with the virtual objects. In one example, the virtual user representation may be shown as a gray shadow and not be able to interact with virtual objects. As the virtual objects come within a certain distance of the virtual user representation, the grey shadow may change to a color shadow and the user may begin to interact with the virtual objects.

The embodiments discussed herein are illustrative. Various modifications or adaptations of the methods and/or specific structures described may become apparent to those skilled in the art. The breadth and scope of a preferred embodiment should not be limited by any of the above-described exemplary embodiments.

What is claimed is:

1. An interactive video display system, comprising:
a light source configured to deliver a pattern of invisible light to a physical object occupying a three-dimensional space;
a camera configured to image the three-dimensional space and detect invisible light scattered by the physical object;
a computing device configured to:
analyze information generated by the camera in response to the detection of the invisible light scattered by the physical object,
map the position of the physical object within the three-dimensional space based on the analyzed information, and
generate a responsive image based on the mapped position of the physical object, the responsive image including a virtual object, the virtual object being responsive to an interaction with the physical object; and
a display configured to present the responsive image.

2. The interactive video display system of claim 1, wherein the camera is a stereo camera.

3. The interactive video display system of claim 1, wherein the analyzed information corresponds to a hand of a user.

4. The interactive video display system of claim 1, wherein the virtual object represents a body of a user.

5. The interactive video display system of claim 1, wherein the virtual object represents a hand of a user.

6. The interactive video display system of claim 1, wherein the pattern of invisible light is infrared.

7. The interactive video display system of claim 1, wherein the responsive image is presented in real-time.

8. The interactive video display system of claim 1, wherein the computing device is further configured to send and receive data via a network, the data including the responsive image.

9. The interactive video display system of claim 1, wherein the light source and the camera are attached to the display.

10. The interactive video display system of claim 1, wherein the three-dimensional space is partitioned into a plurality of zones and different types of user interactions occur in each of the plurality of zones.

11. A method for providing an interactive display system, the method comprising:
delivering a pattern of invisible light to a physical object occupying a three-dimensional space;
detecting the invisible light scattered by the physical object, wherein the detection of the invisible light scattered by the physical object occurs at a camera imaging the three-dimensional space;
analyzing the information generated by the camera in response to the detection of the invisible light scattered by the physical object;
mapping the position of the physical object within the three-dimensional space based on the analyzed information;
generating a responsive image based on the mapped position of the physical object, the responsive image including a virtual object, the virtual object being responsive to an interaction with the physical object; and
presenting the responsive image.

12. The method of claim 11, wherein the camera is a stereo camera.

13. The method of claim 11, wherein the analyzed information corresponds to a hand of a user.

14. The method of claim 11, wherein the virtual object represents a body of a user.

15. The method of claim 11, wherein the virtual object represents a hand of a user.

16. The method of claim 11, wherein the pattern of invisible light is infrared.

17. The method of claim 11, wherein the responsive image is presented in real-time.

18. The method of claim 11, further comprising sending and receiving data via a network, the data including the responsive image.

19. The method of claim 11, wherein the delivering and the detecting occur above the presented responsive image.

20. The method of claim 11, wherein the three-dimensional space is partitioned into a plurality of zones and different types of user interactions occur in each of the plurality of zones.
